(19) United States
(12) Patent Application Publication
(10) Pub. No.: US 2005/0214642 A1
(43) Pub. Date: Sep. 29, 2005

(54) Electrode package and secondary battery using the same

(76) Inventors: Ki-Ho Kim, Suwon-si (KR); Yong-Sam Kim, Suwon-si (KR); Jae-Yul Ryu, Suwon-si (KR); Jae-Kyung Kim, Suwon-si (KR)

Correspondence Address: Robert E. Bushnell, Suite 300, 1522 K Street, N.W., Washington, DC, 20005-1202, US

(21) Appl. No.: 11/091,369

(22) Filed: Mar. 29, 2005

(30) Foreign Application Priority Data
Mar. 29, 2004 (KR) 10-2004-0021170
Mar. 30, 2004 (KR) 10-2004-0021590

(51) Int. Cl. H01M 2/26

(52) U.S. Cl. 429/211; 429/161

(57) ABSTRACT

The secondary battery may be constructed with an electrode package including an electrode assembly including a positive electrode, a negative electrode, and a separator interposed between those two electrodes, each of the positive and negative electrodes may have region uncoated with active material along the edge thereof; and a positive lead and a negative lead fixed to the uncoated regions of the positive and negative electrodes, respectively, with the direction along the length thereof being parallel with the direction along the lengths of the uncoated regions of the positive and negative electrodes; a container having an interior to receive the electrode package; and a cap assembly fixed across an opening of the container to seal the container. The cap assembly may have terminals to be electrically connected to the positive lead and the negative lead, wherein the electrode assembly is mounted in the container at a predetermined angle between its direction of width thereof and the height of the container.

### CLAIM OF PRIORITY

This application makes reference to, incorporates the same herein, and claims all benefits accruing under 35 U.S.C. 119 from two applications for letters patent entitled ELECTRODES ASSEMBLY AND SECONDARY BATTERY USING THE SAME earlier filed respectively in the Korean Intellectual Property Office on 29 Mar. 2004 and 30 Mar. 2004 and there, duly assigned Serial Nos. 10-2004-0021170 and 10-2004-0021590, respectively.

### BACKGROUND OF THE INVENTION

1. Technical Field

The present invention relates to a secondary battery and, more particularly, to an assembly structure of an electrode and a lead fixed thereto in an electrode package for a secondary battery.

2. Related Art

Unlike a primary battery, a secondary battery may be recharged. Common types of secondary batteries may be made into a battery pack and used as the power source for various portable electronic devices such as cellular phones, laptop computers, and camcorders.

Recently, a high power battery using the secondary battery has been developed for use as a power source of motor for a hybrid electric vehicle (HEV).

Depending on the external shape, secondary batteries may be classified into different types, for example, square and cylindrical batteries. The square-shaped secondary battery has a structure with a belt-shaped positive electrode and negative electrode, and with a separator interposed therebetween; the electrodes and separator are stacked and wound into a square-shaped electrode assembly known in the art as a jellyroll, or a plurality of positive and negative electrodes and a separator interposed therebetween, are stacked into an electrode assembly, in both configurations, the electrode assembly is inserted into a square container.

In the electrode assembly with wound positive and negative electrodes, leads are fixedly attached to the positive and negative electrodes, respectively, to collect the electrical current generated between the positive and negative electrodes.

The leads are fixedly attached directly to an external terminal connected, or attached to a separate plate which is connected to an external terminal by welding, to conduct the electrical current flowing between the positive and negative electrodes, to the external positive and negative terminals.

The battery with this above structure can attain sufficient collection efficiency when used for small batteries of low battery capacity. When the battery is used for motor driven devices such as an HEV however, which requires high electrical current and high power, the collecting method mentioned above decreases the collection efficiency and also has difficulty in uniformly collecting the current generated from the positive and negative electrodes because the area of the positive and negative electrodes is increased thereby increasing the size of the battery and accordingly increasing the internal resistance correspondingly.

In an effort to overcome these difficulties, there have been provided secondary batteries including the battery disclosed in Japanese laid-open Patent Application No. 1998-312824 to Hamamatsu et al., entitled RECTANGULAR BATTERY, published on 24 Nov. 1998, and Japanese laid-open No.2002-260672 to Ikeda, entitled RECTANGULAR ALKALINE STORAGE BATTERY, published on 13 Sep. 2002, in which an electrode assembly is formed by stacking a positive electrode, a negative electrode and a separator, and a plurality of leads are attached to the electrodes. In these batteries, because a plurality of leads attached to the electrodes can be fixed to a plate connected to an external terminal, the internal resistance of the battery can be reduced and the collection efficiency from the positive and negative electrodes can be increased. The method of manufacturing this secondary battery includes the steps of preparing a plurality of positive and negative electrodes, attaching leads to the positive and negative electrodes respectively, sequentially stacking the positive and negative electrodes with a separator interposed between them, and tying and connecting the leads attached to the positive electrode and the leads fixed to the negative electrodes; this manufacturing method creates a problem because the number of the manufacturing steps is necessarily increased and the manufacturing efficiency is thereby decreased.

### SUMMARY OF THE INVENTION

There is provided an electrode package and a secondary battery which can uniformly extract the current generated from every portion of the electrode assembly, and can also increase the collection efficiency via the leads to enhance the power characteristics of the battery.

There is also provided an electrode package and a secondary battery in which the structural arrangement of the electrode assembly and the leads can be simplified to increase the manufacturing efficiency.

According to one aspect of the present invention, an electrode package for a secondary battery may be constructed with, an electrode assembly including a positive electrode, a negative electrode, and a separator interposed between those two electrodes, with each of the positive and negative electrodes having region uncoated with active material along the edge thereof. A positive lead and a negative lead may be fixedly attached to the uncoated regions of the positive and negative electrodes, respectively, and the direction along the length thereof is parallel with the direction along the length of the uncoated regions of the positive and negative electrodes.

The uncoated regions can be arranged to form many folds, and they can have a binding region in at least one portion thereof.

The binding region can be arranged in the center portion of the uncoated regions.

The lead can be disposed to be overlapped with the binding region.

The binding region can be formed in the entire portion of the uncoated regions.

The widths of the uncoated regions can be less than three times the thickness of the electrode assembly.

The electrode package meets the following formula:
t/2+a≦W≦t+a
where “W” is the width of the uncoated region, “a” is the width of the lead, and “t” is the thickness of the lead.

The leads can be closely contacted with and fixedly attached to the outermost surfaces of the corresponding uncoated regions, respectively.

The uncoated regions can have an incised portion in at least one portion thereof, and the leads can be inserted into the uncoated regions through the incised portions of the corresponding uncoated regions, respectively, to be in close contact with and fixed to the uncoated regions.

According to another aspect of the present invention, a secondary battery may be constructed with an electrode package including an electrode assembly which has a positive electrode, a negative electrode, and a separator interposed between those two electrodes. Each of the positive and negative electrodes has region that is uncoated with an active material along the edge thereof, and a positive lead and a negative lead fixedly attached to the uncoated regions of the positive and negative electrodes, respectively. The direction along the length thereof is parallel with the direction along the length of the uncoated regions of the positive and negative electrodes. A container receives the electrode package; and a cap assembly is fixed to an opening of the container to seal the container. The cap assembly has terminals that are electrically connected to the positive lead and to the negative lead. The electrode assembly is mounted within the container to establish a predetermined angle between the direction along the width of the electrode assembly and the direction along the height of the container.

The secondary battery may have a square shape.

The secondary battery may be used for a motor driven device.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a front view of an electrode package according to one implementation of a first embodiment of the present invention;

FIG. 2 is a plan view of the electrode package for the first embodiment of the present invention;

FIG. 3 is a partial cross-sectional view of the electrode package illustrated by FIG. 2;

FIG. 4 is an exploded perspective view of the electrode assembly shown in FIG. 2, illustrating the structure of the electrode assembly before winding;

FIG. 5 is a side view of the electrode assembly illustrated by FIG. 1;

FIG. 6 is a side view illustrating the structure of an electrode package according to a modified implementation of the first embodiment of the present invention;

FIG. 7 is a cross-sectional view of a secondary battery constructed according to the principles of the present invention; and

FIG. 8 is a perspective view of an electrode package according to a second implementation of an embodiment of the present invention.

### DETAILED DESCRIPTION OF THE INVENTION

Reference will now be made in detail to the embodiments of the present invention, examples of which are illustrated in the accompanying drawings. The embodiments are described below to explain the principles of the present invention by reference to the figures.

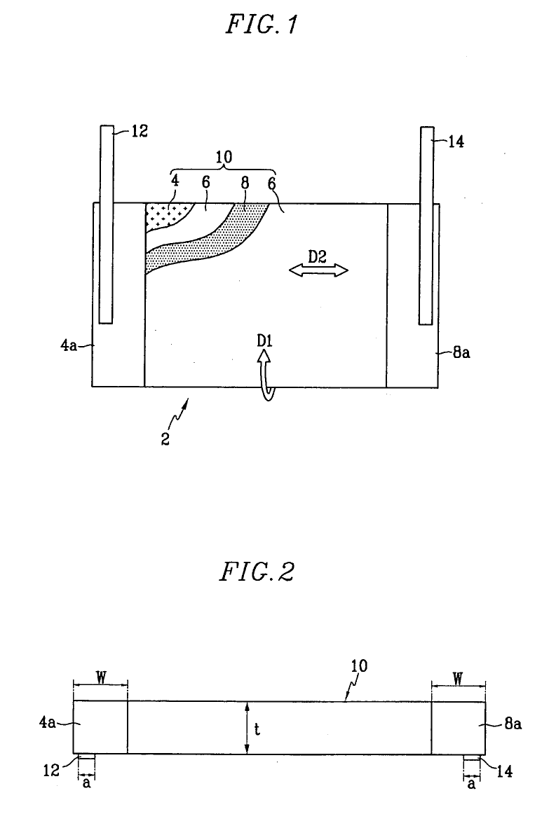

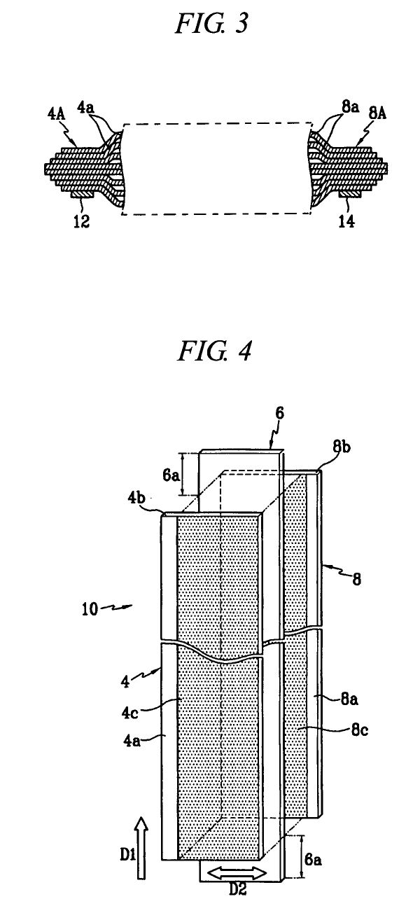

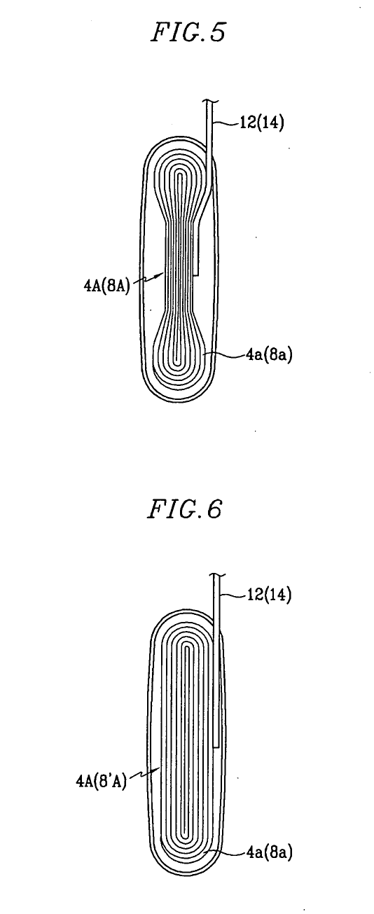

FIG. 1 and FIG. 2 are a front view and a plan view, respectively, of an electrode package according to one implementation of an embodiment of the present invention. FIG. 3 is a partial cross-sectional view of the electrode package for the package, illustrated by FIGS. 1 and 2. FIG. 4 is an exploded perspective view illustrating the structure of the electrode assembly constructed according to the principles of the present invention.

Referring to the drawings, electrode package 2 has electrode assembly 10 with a jellyroll configuration formed by stacking positive electrode 4, separator 6 and negative electrode 8 arranged in a belt shape, and wound along the direction of length D1 in FIGS. 1 and 4, and pressed together.

When electrode assembly 10 is formed, uncoated regions 4a and 8a, respectively, of positive electrode 4 and negative electrode 8 are arranged to face each other. Uncoated regions 4a and 8a are portions of a collector 4b of positive electrode 4 and a collector 8b of negative electrode 8, which are uncoated with active material along an edge of one end that is parallel with the direction D1 of length of these collectors 4b and 8b when positive active material 4c and negative active material 8c are coated on collectors 4b and 8b, respectively. When electrode assembly 10 is formed, these uncoated regions 4a and 8a protrude over separator 6 that is interposed between positive electrode 4 and negative electrode 8 while uncoated regions 4a, 8a maintain their overlapped structure in many folds.

The length of an electrically insulating material forms a separator 6 that is longer than the lengths of positive electrode 4 and negative electrode 8 to prevent a short-circuit from occurring between positive electrode 4 and negative electrode 8. Accordingly, it is preferable that separator 6 have a spare portion 6a at its two opposite ends to prevent overlapping between positive electrode 4 and negative electrode 8, while separator 6 is arranged between positive electrode 4 and negative electrode 8.

Positive electrode 4 and negative electrode 8 are stacked with separator 6 interposed between those two electrodes, and are wound along their direction of length to form electrode assembly 10 in a jellyroll configuration. Electrode assembly 10 may have a core (not shown) at its center to facilitate the winding of electrode assembly 10.

Accordingly, as a result of positive electrode 4 being wound several times, positive uncoated region 4a is arranged in many folds at one end of electrode assembly 10. At the other end of electrode assembly 10, negative uncoated region 8a is arranged in many folds, as a result 7 of negative electrode 8 being wound several times.

In electrode assembly 10, a positive lead 12 and a negative lead 14 are arranged so that their direction of length D1 is parallel to the direction of length D2 of uncoated regions 4a and 8a, and they are electrically connected respectively to positive uncoated regions 4a and negative uncoated region 8a.

Positive and negative uncoated regions 4a and 8a have bound side regions 4A and 8A in order for the many folds of these uncoated side regions to be electrically connected to each other, bound regions 4A, 4B are formed by closely fastening the many folds of each uncoated region 4a, 8a in at least one portion.

Positive and negative leads 12 and 14 respectively overlap binding regions 4A and 8A, and are electrically connected together with respective outermost portions of the positive and negative uncoated regions 4a and 8a, as illustrated in FIGS. 3 and 5.

The binding regions are not limited to the above structure, and may be formed in the entire portion of uncoated regions 4a, 8a as shown in FIG. 6.

Leads 12 and 14 are fixed to the outermost surfaces of uncoated regions 4a, 8a where 11 such binding regions 4A and 8A are formed.

After electrode assembly 10 is formed, binding regions 4A, 8A may be formed by forcing the portions of uncoated regions 4a, 8a corresponding to binding regions 4A and 8A toward the center of electrode assembly 10 to closely contact each other both physically and electrically, and then melting them with heat provided from an external source so that the several folds of binding regions 4A, 8A adhere to each other. For this purpose, ultrasonic welding or resistance welding may be used.

As shown in FIG. 2, the widths (W) of positive and negative uncoated regions 4a, 8a exposed outside separator 6 are preferably less than three times, and even more preferably are less than two times, the thickness (t) of electrode assembly 10.

In addition, the electrode package meets the following formula:
t/2+a≦W≦t+a (1)
where “W” is the width of positive and negative uncoated regions 4a, 8a, “a” is the width of lead 12, 14, and “t” is the thickness of lead 12, 14.

It is more preferable that the electrode package further meets the following formula:

$$\frac{t}{2} + a \leq W \leq \frac{\sqrt{2 t}}{2} + a \qquad ( 2 )$$

When the positive and negative electrodes are formed by coating the active materials on collectors 4b, 8b, respectively, uncoated regions 4a and 8a have at least spare width where positive and negative leads 12 and 14 can be fixed without affecting the collection of electrical current. Accordingly, positive and negative electrodes 4 and 8 can maximize the coating area of the active material on collectors 4b and 8b in order to increase the capacity of electrode assembly 10, which enables the secondary batteries to be constructed with a larger size able to furnish higher power.

Moreover, as mentioned above, the direction along the lengths of positive and negative leads 12, 14 of electrode package 2 are arranged to correspond to winding direction D1 for electrode assembly 10, rather than to correspond to the direction D2 along the width of electrode assembly 10. Such an arrangement of positive and negative leads 12, 14 can minimize the uncoated portion in electrode package 2, especially, the area occupied by positive and negative leads 12, 14, when the secondary battery is formed with electrode package 2. Accordingly, the secondary battery provides an advantage by increasing the capacity.

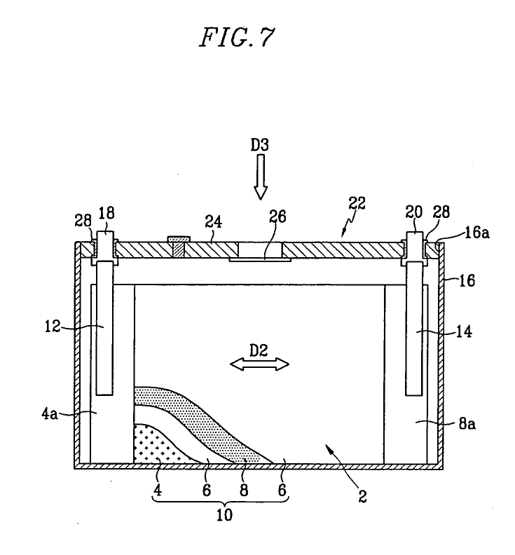

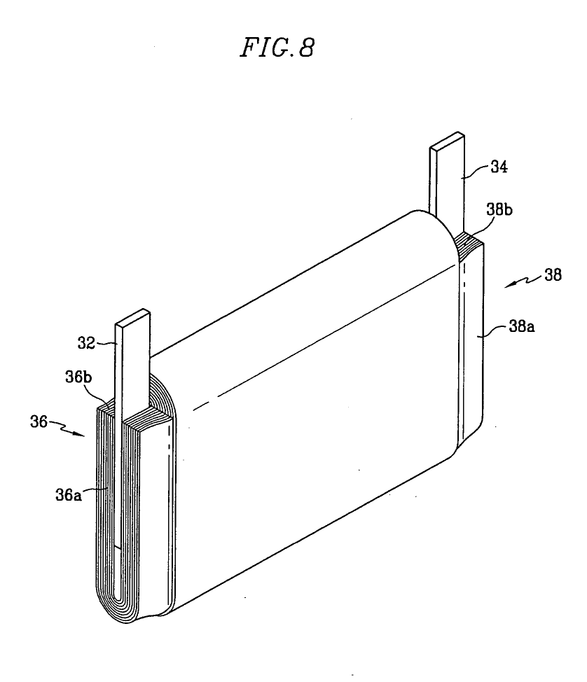

FIG. 7 is a cross-sectional view of a secondary battery according to another implementation of the present invention.

As shown in FIG. 7, the secondary battery includes an electrode package 2 having an electrode assembly 10, and positive and negative leads 12, 14, a container 16 having an opening 16a formed on one of its sides and internal space to receive a plurality of electrode packages 2 inside the container, and cap assembly 22 mounted across opening 16a to seal container 16.

The direction D2 of the width of electrode assembly 10 is not coincident with the direction of D3 insertion of electrode package 2 through opening 16a toward the interior of container 16; that is, the direction of the height of container 16, to form a predetermined angle between them. For example, electrode assembly 10 is disposed such that its direction D2 of width is perpendicular to the direction of height of container 16. Accordingly, positive and negative leads 12, 14 are arranged such that the direction D1 along their length is parallel with the direction of the height of container 16.

Container 16 is made of an electrically conductive metal such as aluminum, aluminum alloy, and steel plated with nickel, and its shape can be multi-sided such as a polygon or a hexahedron, etc. which has an interior volume sufficient to receive electrode package 2. As an example, FIG. 7 shows that electrode assembly 10 of a square shape that is mounted inside container 16 which has a hexahedral shape.

Cap assembly 22 has a base plate 24 fixedly attached to opening 16a to seal container 16, and positive and negative terminals 18, 20 fixedly attached to base plate 24 to be electrically connected to positive and negative leads 12, 14 of electrode package 2, respectively, by passing through base plate 24.

An electrically insulating member 26 may be disposed between base plate 24 and positive and negative terminals 18, 20. A safety vent 26 may be formed in the center of base plate 24, to be broken to discharge gas when the internal pressure of the gas accumulated inside the battery increases to a predetermined value.

In a secondary battery with the above-described structure, positive and negative leads 12, 14 are arranged so that the direction of their lengths is parallel with the direction D3 for the insertions of electrode assembly 2 through opening 16a toward the interior of container 16, and their opposite terminal ends are fixed to the lower ends of positive and negative terminals 18, 20, respectively.

Such an arrangement of positive and negative leads 12, 14 enables positive and negative leads 12, 14 to respectively connect positive and negative electrodes 4, 8 with the corresponding positive and negative terminals 18, 20 while minimizing the extension of their respective lengths, which can shorten the path of the current flow from electrode assembly 10 to positive and negative terminals 18, 20.

Such an arrangement of positive and negative leads 12, 14 decreases the internal resistance of the secondary battery together with the assembly structure of positive and negative uncoated regions 4a and 8a and positive and negative leads 12, 14, which can increase the electrical power capacity of the secondary battery to a degree that the battery may be reliably used for motor driven devices like HEVs.

FIG. 8 is a perspective view of an electrode package according to a second implementation of an embodiment of the present invention. Electrode package 30 has the same basic structure as the electrode package mentioned above, the details of which need not be again described here.

A positive lead 32 and a negative lead 34 of electrode package 30 are also electrically connected to uncoated regions 36a, 38a of positive electrode 36 and negative electrode 38 in electrode package 30.

In the structure for the electrical connections, as mentioned above, positive lead 32 and negative lead 34 are arranged so that the directions of their lengths are parallel with the directions of the lengths of positive uncoated region 36a and negative uncoated region 38a.

Positive uncoated region 36a and negative uncoated region 38a have incised portions 36b, 38b in one section thereof (the upper sections in this embodiment with respect to the drawing), and positive and negative leads 32, 34 are inserted into uncoated regions 36a, 38b through incised portions 36b, 38b to be fixedly attached to form corresponding electrical connections to uncoated regions 36b, 38b.

That is, unlike the earlier embodiment, positive and negative leads 32, 34 in this embodiment are not attached to the outermost surfaces of the corresponding uncoated regions 36b, 38b, but are physically inserted into uncoated regions 36b, 38b to be attached between them.

The secondary battery of the present invention can be used as the power source for motor driven devices such as the hybrid electric vehicles, electric vehicles, wireless vacuum cleaners, motorbikes, or motor scooters.

The secondary battery of the present invention will minimize its internal resistance, uniformly extract the current generated from the electrode assembly, and increase the collection efficiency of the positive and negative leads with the structural assembly of the positive and negative leads, the positive and negative terminals, and the uncoated regions of the positive and negative electrodes.

Accordingly, the secondary battery of the present invention can be used as a high power battery for motor driven devices due to its increased electrical characteristics, and it can increase the manufacturing efficiency due to the simplified structural assembly for the electrodes and the leads.

Although a few embodiments of the present invention have been shown and described, it would be appreciated by those skilled in the art that changes may be made in this embodiment without departing from the principles and spirit of the invention, the scope of which is defined in the claims and their equivalents.

1. An electrode package for a secondary battery, comprising:
an electrode assembly comprising a positive electrode, a negative electrode, and a separator interposed between those two electrodes, each of the positive and negative electrodes having an uncoated region uncoated with active material along an edge thereof; and
a positive lead and a negative lead fixed to the uncoated regions of the positive and negative electrodes, respectively, a direction of length thereof being parallel with a direction of length of the uncoated regions of the positive and negative electrodes.

2. The electrode package for a secondary battery of claim 1, wherein the uncoated regions are arranged to form a plurality of folds and a binding region in at least one portion thereof.

3. The electrode package for a secondary battery of claim 2, wherein the binding region is arranged in a center portion of the un coated regions.

4. The electrode package for a secondary battery of claim 2, wherein the lead is disposed to overlap the binding region.

5. The electrode package for a secondary battery of claim 2, wherein the binding region is formed over an entire portion of the uncoated regions.

6. The electrode package for a secondary battery of claim 1, wherein widths of the uncoated regions are less than three times a thickness of the electrode assembly.

7. The electrode package for a secondary battery of claim 1, wherein the electrode package meets the following formula:
t/2+a≦W≦t+a
where “W” is a width of the uncoated region, “a” is a width of the lead, and “t” is a thickness of the lead.

8. The electrode package for a secondary battery of claim 7, wherein the electrode package further meets the following formula:
$$\frac{t}{2} + a \leq W \leq \frac{\sqrt{2 t}}{2} + a .$$

9. The electrode package for a secondary battery of claim 1, wherein the leads in close electrical and physical contact with and fixed to outermost surfaces of the corresponding uncoated regions.

10. The electrode package for a secondary battery of claim 1, wherein the uncoated regions have an incised portion in at least one section thereof, and the leads are inserted into the uncoated regions through the incised portions of the corresponding uncoated regions, to be closely electrically contact the uncoated regions.

11. A secondary battery, comprising:
an electrode package comprised of:
an electrode assembly comprising a positive electrode, a negative electrode, and a separator interposed between the negative electrode and the positive electrode, each of the positive and negative electrodes having an uncoated region uncoated with active material along edges thereof; and
a positive lead and a negative lead fixedly connected to the uncoated regions of the positive and negative electrodes, respectively, the direction of length thereof being parallel with the direction of length of the uncoated regions of the positive and negative electrodes;
a container having an interior volume to receive the electrode package; and
a cap assembly fixed to an opening of the container to seal the container, the cap assembly comprising electrical terminals to be electrically connected to the positive lead and the negative lead;
the electrode assembly being mounted in the interior volume to form a predetermined angle between a direction of width and a direction of height of the container.

12. The secondary battery of claim 11, wherein the electrode assembly is arranged with the direction of width being perpendicular to the direction of height of the container.

13. The secondary battery of claim 11, wherein the leads are arranged with the direction of length parallel to the direction of height of the container.

14. The secondary battery of claim 11, wherein the uncoated regions are arranged to form a plurality of folds with a binding region in at least one portion thereof.

15. The secondary battery of claim 14, wherein the lead is disposed to overlap with the binding region.

16. The secondary battery of claim 14, wherein the binding region is formed over an entire portion of the uncoated regions.

17. The secondary battery of claim 11, wherein the leads are disposed in close electrical contact with and fixedly connected to outermost surfaces of the corresponding uncoated regions.

18. The secondary battery of claim 11, wherein the uncoated regions have an incised portion in at least one section thereof, and the leads are inserted into the uncoated regions through the incised portions of the corresponding uncoated regions to be in close electrical contact with and fixedly attached to the uncoated regions.

19. The secondary battery of claim 11, wherein the secondary battery has a square shape.

20. The secondary battery of claim 11, wherein the secondary battery is for providing electrical power to drive a motor driven device.
